(19) United States
(12) Patent Application Publication
(10) Pub. No.: US 2002/0004424 A1
(43) Pub. Date: Jan. 10, 2002

(54) Method, apparatus and system for an electronically distributed game of skill

(76) Inventors: David C. Nelson, Las Vegas, NV (US); Shawn R. Huggins, Las Vegas, NV (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/835,942

(22) Filed: Apr. 16, 2001

Related U.S. Application Data
(60) Provisional application No. 60/197,098, filed on Apr. 14, 2000.

(51) Int. Cl. A63F 13/00

(52) U.S. Cl. 463/42

(57) ABSTRACT

Embodiments of the instant invention are directed to a method, apparatus, and system for an electronic game of skill, wherein multiple remotely located players can compete for a common prize. In preferred embodiments, a user accesses the game via a wide area network or by some other remote means and inputs required information, including payment information. Preferably, the player then authorizes the payment of the entry fee and competes in a contest of skill, preferably a trivia game, where a prize or prizes are awarded to players that reach a predetermined performance level. Preferred embodiments of the present invention include, without limitation, multi-tiered, pari-mutuel and progressive prize pay-out methods.

### PRIORITY CLAIM

This application claims the benefit of U.S. Provisional Application No. 60/197,098,filed Apr. 14, 2000.

### FIELD OF THE INVENTION

The instant invention is directed to a method, apparatus and system for playing a skill game; in particular, an electronic gaming method, apparatus and system played by the end users on one or more wide area computer networks or other computer network means, or by the use of a telephone, personal digital assistant, pulse code system, Web TV, or any other device or method that communicates alpha numeric data with a server, wherein, upon the payment of an entry fee, one or more players can receive prizes for achieving predetermined performance levels in a game of skill.

### BACKGROUND OF THE INVENTION

Televised game shows have been a popular from of entertainment in the U.S. for more than four decades. One disadvantage of television game shows is that a very limited number of people can actually appear on the show and compete for prizes. Most people are limited to passively watching the televised game shows, or to playing along with the shows without having any chance to win a prize.

Since the advent of wide area networks, such as, for example, the Internet or the World Wide Web (“WWW”), global participation in games has become possible. Indeed, both skill-based and chance-based gaming enterprises have developed Web sites over wide area networks that offer a variety of gaming activities. These enterprises can generally be broken down into two categories, free sites and gambling sites.

### Free Sites

Many sites on the Internet offer a variety of skill-based and chance-based games that are free for players to participate in. These entertainment game sites (“Free Sites”) are popular and experience high traffic. Typically, the Free Sites derive revenue from advertising to players during, and between, games.

Although gaming on wide area networks provides players with convenient access to games, one problem with the Free Sites offered via computer networks, or in some other remote manner, is that it is not economically feasible for the Free Sites to offer significant prizes to their players. This is because typically the sites' only source of revenue is derived from advertising. Therefore, players on Free Sites are left to compete primarily for the sake of competition and/or for recognition from other competitors.

Another typical disadvantage of Free Sites is that the winners of even the modest prize offerings are generally chosen by random drawing. Sometimes a player on a Free Site may be able to increase their chances of winning a prize in a random drawing by playing the game more often, but traditionally a player's ability to win a prize is not directly related to their success as a participant in a game. Therefore, even in the Free Sites' skill-based games the winners are chosen by chance.

### Gambling Games

Vast numbers of people are also intrigued by gambling games in which a player risks money on a chance event, with the hope of receiving a return upon the occurrence of the event. Indeed, cities such as Las Vegas and Atlantic City have established their economic success primarily through offering gambling entertainment. The intrigue of gambling on games of chance is based, in part, on the thrill of the risk involved and the opportunity for enormous returns based upon the risk taken. Although most people do not gain enormous returns on their wagers, people continue to play because of the possibility for a return.

In gambling, the amount of the available winnings, or prize, that a player competes for is generally a function of the amount that a player wagers and the predetermined odds of the occurrence of a random event. The outcome of gambling games are inherently based upon chance, not skill.

In the United States games of chance are regulated by both the federal and state governments. Localized gaming has been established in particular places, such as, for example, foreign countries, states which have legalized gaming, and in territories where gaming is legal, such as, on Indian reservations. A problem with these gaming opportunities is that their locations are not convenient for most people. Thus, many people who cannot afford to travel to these locations cannot participate in the gaming experience.

Internet gambling has become a more and more accepted and popular way for people to seek gambling entertainment. Internet gambling allows people all over the world to play gambling games at any time. Currently, many sites (“Gambling Sites”) offer players the opportunity to wager on games of chance over a wide area network, including, but not limited to, traditional casino games like slot machines, video poker, blackjack, craps, roulette, baccarat, pai gow and/or other games of chance like bingo.

Unfortunately, disadvantages to Gambling Sites' players include, but are not limited to, the following:

1. It is virtually impossible to determine if a game is fair, or if it is being manipulated by site operators;

2. In most instances, the player faces the risk of prosecution associated with gambling from a jurisdiction in which gambling is prohibited; and

3. The success of a player is determined almost solely by chance.

### SUMMARY OF THE DISCLOSURE

Unlike current methods for remote game play, including, but not limited to, those offered on Free Sites or Gambling Sites, embodiments of the instant invention (the “Game”) provide remotely located players with the potential to compete for large prizes in a game over a wide area network, where the outcome of the game is determined primarily by their own skill.

In preferred embodiments, a user accesses the Game via a wide area network or by some other remote means. The user is requested to input information regarding identification of the user and payment means. Once the user has provided the requested information and paid an entry fee, the user accesses a gaming page which allows players to participate in a game of skill. Based upon the player's performance in the game of skill, they may be awarded a prize.

It is an advantage that the game is skill-based, because many players find it more enjoyable to “control their own destiny,” and not leave their possibility of success to chance. It is also advantageous that the results of the game of skill are objectively determinable, making it easy for a player to verify the game is not “rigged” or being manipulated by the site owners.

In preferred embodiments, all players that reach a predetermined performance level win a share of the prize pool. It is an advantage that, because players are not competing against each other, players can win a share of the prize pool irrespective of other players' skill.

It is also an advantage that, unlike Gambling Sites, the Game operators and players will likely avoid gaming regulations. This is because the Game is based upon skill and not chance, and therefore will likely not be regulated by the Federal government and most states.

In preferred embodiments, the prize pool pay-out is pooled or pari-mutuel. That is, preselected percentages of each player's entry fee are deposited in the prize pool, and the remainder of the entry fee is revenue for the company. This feature of the Game allows for a completely self-finding prize pool that can quickly grow to be quite substantial in size. It is also an advantage of this feature that the Game operators, unlike Free Sites, will receive a source of revenue other than from advertising. This also provides an advantage to the Game's players, as it is economically feasible for the Game operators to offer free promotional games with subsidized prize pools.

Preferably, the amount of the available prize pool for the Game is determined by the number of players participating in that game. This feature assures that the prize pool grows as more players join the Game.

In some preferred embodiments, the Game's pay-out is multi-tiered, with a player having the opportunity to win a preselected percentage of the prize pool by reaching a predetermined performance level in the game of skill, and then to win an additional preselected percentage of the prize pool by reaching a more difficult predetermined performance level in the game of skill, and so on. This feature creates the advantage of more players having the opportunity to receive prizes as they participate in the Game.

Preferably, the prize pool is progressive in that any amounts in the prize pool that are not won during a Game are carried to the next Game. It is an advantage of the present invention that when the progressive feature is added to a game of skill, it creates the possibility of larger prize pool offerings.

Another feature of the preferred embodiments is that the Game is available to a global market over a wide area network. Therefore, based on the pari-mutuel and progressive nature of the Game, the potential returns to successful players can be quite large.

It is a further advantage of the instant invention that in preferred embodiments the Game can be played 24 hours a day by a virtually unlimited number of players.

The above and other advantages of embodiments of this invention will be apparent from the following more detailed descriptions. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of embodiments of the invention will be made with reference to the accompanying drawings, wherein like numerals designate corresponding parts in the figures.

FIG. 1 is a wide area network system environment in accordance with a preferred embodiment of the instant invention.

FIG. 2 depicts a block diagram of a preferred embodiment of the instant invention.

FIG. 3 depicts a preferred embodiment of the entry fee distribution of the preferred embodiment diagramed in FIG. 2.

FIG. 4 depicts a preferred embodiment of a game of skill of the preferred embodiment diagramed in FIG. 2.

FIG. 5 depicts another preferred embodiment of a game of skill.

### DETAILED DESCRIPTION OF THE PREFERRED EMBODIMENT

Preferred embodiments of the instant invention operate on a network, such as, for example, the WWW, or another type of remote access system, such as, a kiosk, telephone, personal digital assistant, pulse code system, Web TV, or any other device or method the communicates alpha numeric data with a server.

### Hardware Environment

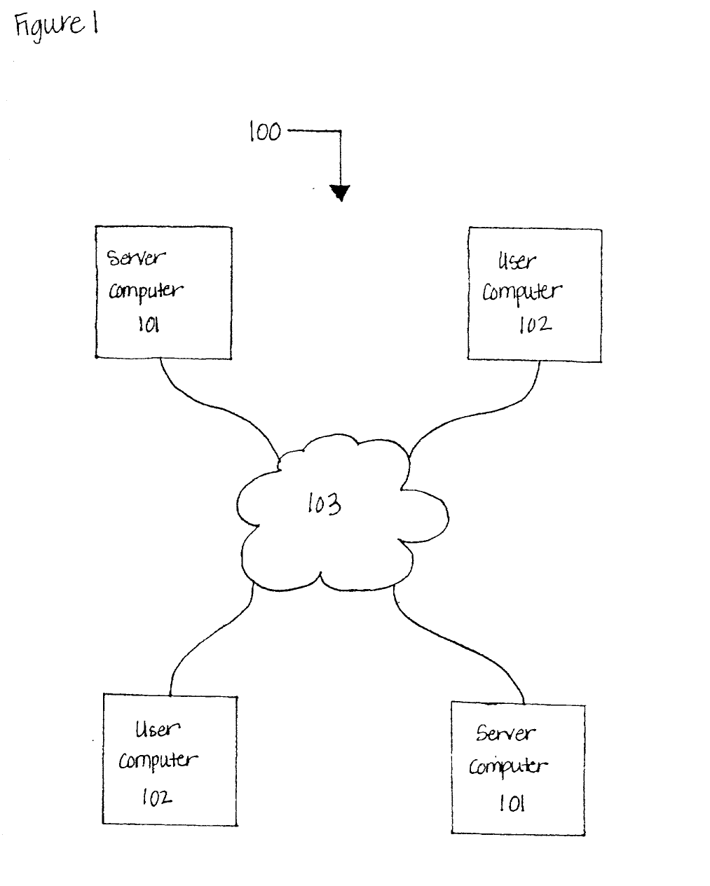

Preferred embodiments of the instant invention operate in accordance with a plurality of networked computers, such as, for example, a user computer and a server computer which are coupled together on a communications network, such as, for example, the Internet or a wide area network. As shown in FIG. 1, preferred embodiments include a wide area network system 100 having a server or provider computer 101, and a client, or user computer 102, wherein the server computer 101 and the user computer 102 are in electronic communication with each other via a communication link 103. In some preferred embodiments, the network system 100 includes a plurality of either the server 101, the user computer 102, or any combination thereof. The server 101 contains gaming data and other relevant data that is accessible by the user computer 102 or users. Preferably, the network 100 includes one or more (and preferably a plurality of) servers 101 that are operatively connected to the communication link 103. It is to be understood that network systems 100 in accordance with further embodiments may include more than two servers 101. The provider computer 101, or server, may comprise any suitable network device capable of providing content (data representing text, hypertext, photographs, graphics video and/or audio) for communication over the network. In preferred embodiments, the provider computer 101 comprises a programmable processor capable of operating in accordance with programs stored on one or more computer readable media (for example, but not limited to, floppy disks, hard disks, random access memory RAM, CD-ROM), to provide content for communication to a user computer 102. The provider computer 101 may comprise, for example, but not limited to, a personal computer, a mainframe computer, network computer, portable computer, personal digital assistant (such as, a 3Com Palm Pilot), or the like. The provider computer 101 may include one or more internal data storage devices for storing content for communication to a user computer 102. Alternatively, or in addition, the provider computer 101 may be coupled to an external data storage device, computer or other means, from which the provider computer 101 may obtain content for communication to a user computer 102. In one embodiment, the external device may comprise a further network device coupled in the network. The provider computer 101 is controlled by suitable software to provide the requested content to the requesting user computer 102, provided that various criteria are met.

In a preferred wide area network environment 100, such as, the Internet environment, the provider computer 101 is controlled by suitable software to respond to a valid request for content by providing (or downloading) data in the form of one or more HTML, or other computer language, files to the user computer 102 from which the request was made. It will be understood by those skilled in the art that this process involves communications through suitable servers, routers and other components, as is dictated by the particular network environment.

Each server 101 advantageously operates with a persistent storage means, for example, one or more of the fixed and/or removable data storage devices and/or data communications devices connected to the computer. The communication link 103 may include a public network, such as the Internet, a local area network, or any other suitable communications connection, hardwired, wireless, or a hybrid thereof.

The user computer 102 may comprise any suitable network device capable of communicating with other network devices in the network system. In preferred embodiments, the user computer 102 comprises a programmable processor capable of operating in accordance with programs stored on one or more computer readable media (for example, but not limited to, floppy disc, hard disc, computer network, random access memory (RAM), CD-ROM, or the like), a display device for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device (for example, but not limited to, a keyboard, mouse, microphone, or the like). In one preferred embodiment, the user computer 102 comprises a personal computer system having a CRT display, a keyboard and a mouse user-input device.

The user computer 102 is controlled by suitable software, including network communication and browser software to allow a user to request, receive and display information (or content) from or through a provider computer on the network system. The user computers 102 operate in accordance with programs stored on a readable medium, including, but not limited to, floppy disks, hard disks, RAM and CD-ROM. The user computers are any means capable of communicating with the server computers 101, including, but not limited, to personal computers, kiosks and ATM-type machines. The user computers 102 access the server computers 101 via the wide area network 100 or through some other remote access, such as, for example, by telephone, personal digital assistant, pulse code system, Web TV, or any other device or method that communicates alpha numeric data with a server.

### General Description of Preferred Embodiments

Preferred embodiments of the instant invention comprise an objective representation of the method of the Game and further provide a method for awarding the Game's prizes.

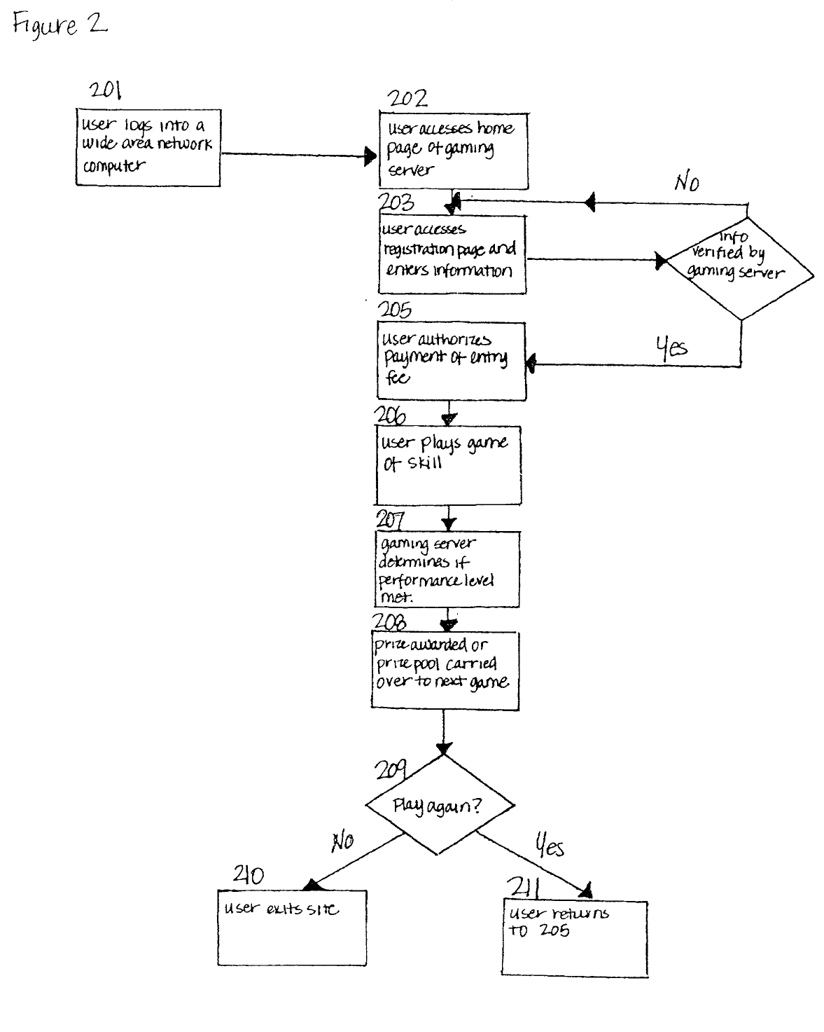

With reference to FIG. 2, players who are desirous of participating in a particular Game, establish a connection on a wide area computer network 201 between a user computer 102 and a gaming server 101. In preferred embodiments, a virtually unlimited number of players can play at any given time and for any given Game. Indeed, in preferred embodiments, global participation in any given Game is possible.

As described above, some preferred embodiments utilize a wide area network system 100, such as the Internet, for transmission and receipt of information for the gaming data. In these preferred embodiments the gaming server 101 transmits information to the player in the form of a Web site. For example, an initial or home page is accessed by the user 202 upon entry into the Game's Web site. The home page is an introductory page that comprises textual information and hyperlinks. In some preferred embodiments, the home page is designed to direct a player to a foreign home page for a specific language wherein the foreign home page displays information and relevant data in the language selected by the player.

The textual information can comprise any type of information that the gaming server 101 chooses. In one preferred embodiment, the textual information comprises gaming information, and rules and regulatory information, which in some embodiments is a link that allows the user to access the rules and regulatory information page. Gaming information may comprise, for example, the available prize pool amount for the next Game, the time until the commencement of the next game, and/or the names of previous Game winners.

In some preferred embodiments, the available prize pool total is displayed in the different currencies of all of the different countries in which the Game is played. Preferably, as more players pay the entry fee 205 for a Game, the prize pool becomes larger (described in detail below). As the prize pool becomes larger, the displayed totals change to reflect the updated information in a preset time interval, such as, for example, every minute or every hour. Preferably, the prize pool display will appear in the user's currency. In one preferred embodiment, a currency converter is provided such that the user can enter their type currency and the converter will display the amount of the prize pool in the user's currency, wherein the conversion is calculated from a chosen currency base, such as, for example, the U.S. dollar, Mexican peso or British pound. In these embodiments, the converter indicates the base currency from which the conversion is performed. In another preferred embodiment, currency conversions are automated.

The rules and other regulatory information can be included directly on the home page, or, in some preferred embodiments, is accessed via a hyperlink from the home page. In some preferred embodiments, a player may also access the rules and regulations from other pages (described below) on the site, or from a number of different pages. If the rules and regulations information is accessed via a hyperlink, the user is directed to a file comprising “How to Play” information, wherein information to play the Game, such as, the rules and regulations, is retrievably stored. Preferably, the Rules and Regulations information comprise information related to the restrictions of the Game, including, but not limited to, information regarding who is eligible to play the Game; how to claim the prize; claims deadlines; disputes resolution; miscellaneous transaction fees; entry provisions; and legal terms. As regulations and rules change, due, for example, to changes in laws or the definition of what indicia determines the Game results, this section is updated to reflect such changes.

The home page includes at least one hyperlink, for example, a “Register” button, such that the player can exit the home page and advance to other pages on the system, wherein the user can ultimately choose selections to play the Game. In one preferred embodiment, the home page comprises hyperlinks to registration or sign-up pages, which are written in English or a number of foreign languages, or as previously discussed, to the rules and regulations file.

In that embodiment, when a user chooses to participate in the Game, the user is required to register 203 prior to commencing play of the Game. Selection of the aforementioned command hyperlink will send the user to a registration page 203.

One preferred embodiment for the registration page comprises a means for the entering of information required to play the Game 203 or optionally sought by the operator of the Game. In one preferred embodiment, the means for entering information is a form wherein the user fills in the requested information. In some preferred embodiments, the type of information requested includes, but is not limited to, the player's name, address, e-mail address, a preferred screen name and password, credit card information, or in-house account information. In preferred embodiments wherein a user is participating from a remote kiosk or ATM-type machine, the user has the option of inserting their credit or debit card information through the use of a credit card reader on the kiosk or ATM-type machine.

Once information has been entered into the registration, the player enters a command, such as a HTML hyperlink embedded in a “Play” button graphic, which moves the user to the next step of the process 204. In some preferred embodiments, a user cannot progress to the next step of the process until all of the information is provided and the underlying transaction has been authorized and cleared 204. In some preferred embodiments, if any part of the registration form is not filled in completely, or if the form of payment is rejected, the player is sent back to the registration page to correct the problem 204.

In some preferred embodiments, once the requested information on the registration page has been provided and transmitted, and the underlying entry fee transaction has been approved 205 and accepted, the user can access the Game page via the gaming server 101. If the inputted information is accepted, the user is issued a screen name and password. The information provided by the user, such as, for example, method of payment information will be stored, and the player can enter the gaming page by providing the screen name and password, and the player will not be required to register again.

Although the above describes basic embodiments of the invention, it is not intended to limit the invention. Indeed, variations on the manner in which information is obtained from the user, or displayed to the user is envisioned. For instance, in some preferred embodiments, the gaming server 101 provides the user access to a “Cookie Page” or player information page. In preferred embodiments, the player information page comprises many of the same features as the gaming page, such as, current prize pool amounts, the player's in-house account balance, the time until the next Game begins, statistics from prior Games and/or a “Rules” hyperlink button.

The player information page allows the user to record and automate payments on-line. This information is not visible to the user; however, it is transferred to the server computer 101 when the user enters the Game utilizing the player information page or cookie page. Other types of encrypted information includes, but is not limited to, language and currency designations. In this way, for example, a wide area network player, such as, an Internet player, does not have to provide all of the payment information for each Game played; thus, allowing the player to save time. In these embodiments, the player information is maintained on the user's computer 102, and is automatically transferred to the gaming server 101 whenever a player (who has designated this option) accesses the server for this purpose.

In some preferred embodiments, the player is given confirmation of the transaction via a confirmation means. In some preferred embodiments wherein the player is playing the Game through a wide area network 100, such as, the Internet, in which e-mail may be transmitted, the player can be e-mailed a written confirmation. In another preferred embodiment, wherein the player is accessing the gaming server 101 via a remote kiosk, the kiosk will print out a confirmation for the player. In other embodiments, other suitable confirmation means may be employed, including, but not limited to, the mail or postal system, telephone and/or telegram.

In some preferred embodiments, the player can choose to be notified by means, including, but not limited to, instant message or e-mail, at a preselected time prior to the commencement of the next Game and/or when the prize pool reaches a certain level.

In one preferred embodiment, a player can access account information, for example, but not limited to, the total amount charged to the player's credit card or other payment selection, such as, a debit card or cyber cash in the prior month. In some preferred embodiments, a player can establish an in-house gaming account to pay for the Game. In these preferred embodiments, the player would select their preferred payment method and deposit funds into the in-house gaming account (the “Gaming Account”). Preferably, a player's Gaming Account information is stored by the gaming server, and when a player, that has previously registered, returns and enters the proper name and password, they are permitted to resume play using the previous balance in their Gaming Account. In these embodiments, the purchase information further comprises an indicator that indicates to the user that the purchase amount has been subtracted from the Gaming Account. It is to be appreciated that the indicator could also indicate additions to the Gaming Account as well, for instance, if the player adds more money to the account or in the event that the player wins the Game, the winnings, or a portion thereof, could be added to the Gaming Account.

Preferably, the payment method is a credit card or other payment selection, such as, a debit card or cyber cash, or other online currency. In some preferred embodiments, if the Gaming Account falls below a certain level, then the player must deposit additional funds into the Gaming Account prior to being permitted to play a game.

Once the players have inputted their gaming information and confirmed payment of the entry fee 205, preferably, the user clicks on a “Play” button which accesses the Game page if the information requirements have been met.

In some preferred embodiments, the Game page is comprised of several distinct areas. For example, but not limited to, an area for a question to appear, an area for multiple choice answers to appear, an area for the question timer, an area or areas to display advertisements, an area to display the total available prize pool, an area to display the number of prize eligible players and/or an area to display the prize amount that each prize eligible player would receive if the Game concluded on that question.

In some preferred embodiments, the number of players that can participate in each Game is unlimited. However, each player is required to pay the entry fee 205 prior to the starting time of the Game, in order to be eligible to participate in that Game. A new Game will commence at predetermined time intervals. In some preferred embodiments, a new Game will commence every 15 minutes.

Preferably, after entering their name and password, the player would authorize the payment of an entry fee 205. In some preferred embodiments, the amount of the entry fee is set by the Game operators. In other preferred embodiments, a player can choose the amount of entry fee that they want to play for each Game. In some preferred embodiments, the amount of this entry fee, would be fixed or limited by the Game operators, in other preferred embodiments the amount of the entry fee would be left to a player's discretion. In those preferred embodiments where the amount of the entry fee is discretionary, the portion of the prize pool that the player wins upon reaching a predetermined performance level is a function, at least in part, of the amount that was paid as an entry fee. For example, but not limited to, a player that paid a higher entry fee would receive a higher pay-out as their share of the prize pool than those that paid a lower entry fee. In one preferred embodiment, the entry fee is $5.00 U.S. In one preferred embodiment, the player will confirm payment of the entry fee by selecting a “Play Game” button at step 205.

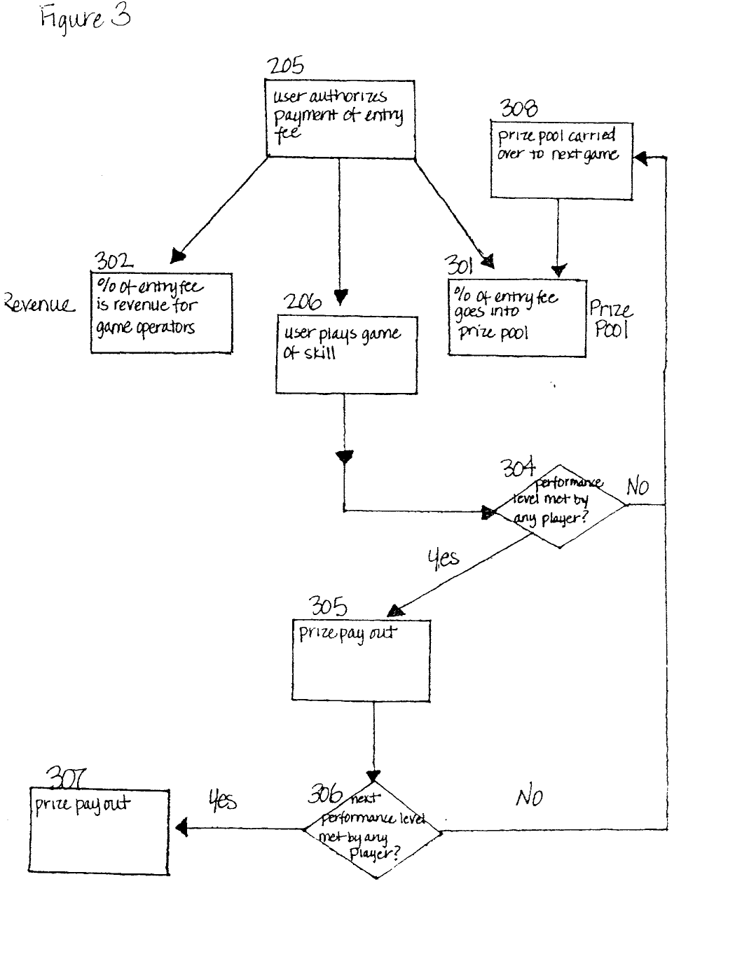

Preferably, the entry fee is apportioned between the prize pool and revenue for the company. In one preferred embodiment, eighty percent (80%) of each player's entry fee goes into the prize pool to be distributed to that Game's winners (if any) 301 (FIG. 3). In that preferred embodiment, the other twenty percent (20%) of the entry fee is revenue for the Game operators 302. In another preferred embodiment, the entire entry fee would go into the prize pool to be distributed to that Game's winners (if any) 302.

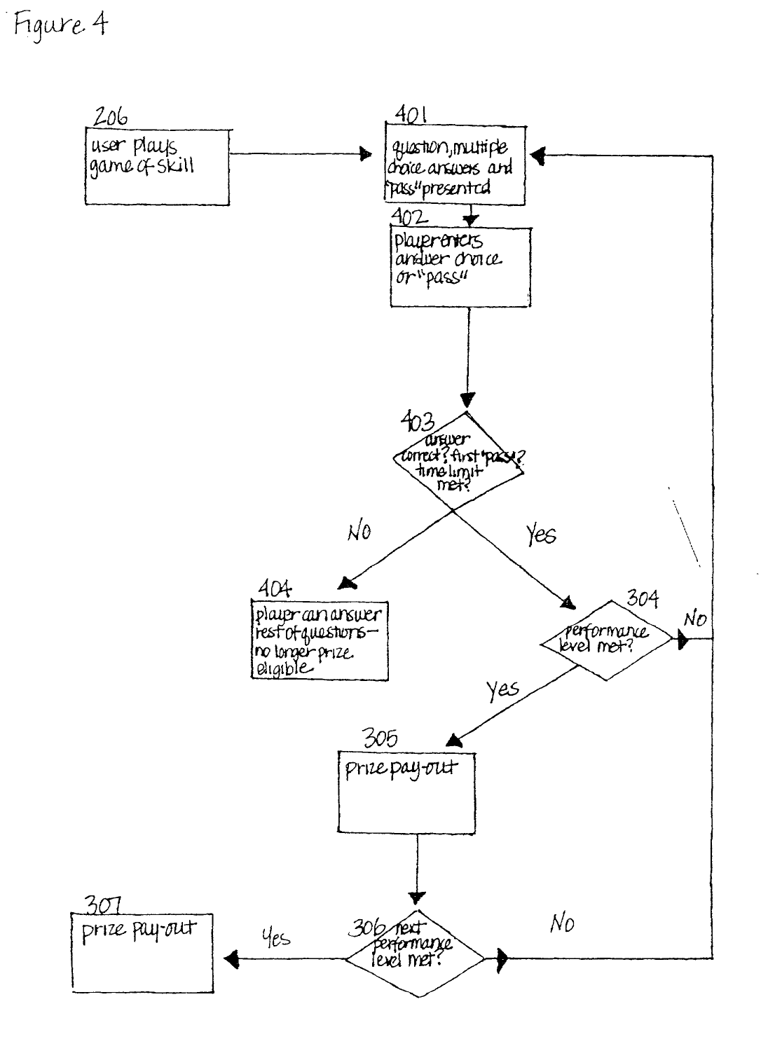

In one preferred embodiment, the Game will begin with a trivia question and four multiple-choice answers appearing on all participating players' screens simultaneously 401 (FIG. 4). Each player would have a limited time to enter their choice for the answer to the question, or to “pass” on that question 402. In one preferred embodiment, the time limit would be twelve seconds.

In one preferred embodiment, the player enters their choice for the answer by selecting an “A”, “B”, “C”, “D”, or “Pass” button on the screen 405. In some preferred embodiments, the player enters their choice for the answer by selecting designated keys on their keyboard.

In another preferred embodiment, the player enters their choice for the answer by selecting an “1”, “2”, “3”, “4”, or “Pass” button on the screen 405. In some preferred embodiments, the player enters their choice for the answer by selecting designated keys on their keyboard.

In some preferred embodiments, by pressing the “Pass” button, a player advances to the next question without being required to answer the current question. Preferably, a player could use this option only once during a Game. In some preferred embodiments, the “Pass” button can be used for any question during that Game, except for the very last question.

In one preferred embodiment, a Game comprises 20 trivia questions that are presented one at a time to all of the players participating in the Game simultaneously. In some embodiments, the trivia questions are randomly chosen by the gaming server 101 from a trivia database. In one preferred embodiment, the trivia questions are randomly chosen from three different pools of question difficulties. For example, without limitation, questions 1 through 7 may be drawn from an “easy pool” of questions, and questions 8 through 14 may be chosen from a “moderate pool” of questions, and questions 15 through 20 may be chosen from a “hard pool” of questions.

In some preferred embodiments the question difficulty is determined by the Game operators and in some preferred embodiments the question difficulty is determined by the gaming server 101, based on the results when that question was presented to previous players.

In some preferred embodiments, once a player misses a question or fails to answer within the required time limit, they are no longer eligible to win a share of the prize pool 404. However, preferably, they will be allowed to continue to play that Game to its conclusion. In some preferred embodiments, at the end of each Game, all players will be provided with statistics relating to their performance in that Game.

In one preferred embodiment, the player, or players, that answer 15 consecutive questions correctly 304 will receive a pro-rata share of twenty-five percent (25%) of the total prize pool 305. The player, or players, that answer all 20 questions correctly 306 would then receive a pro-rata share of the remaining seventy-five percent (75%) of the prize pool 307.

It is to be appreciated that although the above described embodiments utilize 20 questions, a different number of questions can be used. It is also to be appreciated that although the above described embodiments utilize 75% and 25% to divide the prize pool, different percentages can be used. It is to further be understood, that the prize could be items of value other than money, for example, but not limited to, trips, computers and/or cars. It is to be further understood that the winners of the game could be chosen by different criteria. For example, but not limited to, the top ten scorers, or the fastest player to answer a certain number of questions.

In some preferred embodiments, all players that reach a certain performance level in the Game are able to play an additional fee. In some preferred embodiments, the amount of this additional fee, would be fixed or limited by the Game operators, in other preferred embodiments the amount of the additional fee would be left to a player's discretion. In some preferred embodiments, a portion of this additional fee would be revenue for the Game operators. In some preferred embodiments, the remainder of such additional fee would then be placed into a separate prize pool, and only players that had chosen to pay the additional fee would be entitled to win a share of the separate prize pool, upon reaching a predetermined performance level. In other preferred embodiments, the remainder of such additional fee would go into the Game's prize pool, and the players that had chosen to pay the additional fee would be entitled to a larger share of the Game's prize pool upon the attainment of the specified performance level or levels than those players that chose to not pay the additional fee. In other preferred embodiments, the entire additional fee goes into the separate prize pool or the Game's prize pool.

Preferably, the Game would also have a progressive feature. In some preferred embodiments, any portion of the prize pool that is not won by a player is carried over to the next game 308. In one preferred embodiment, if no player successfully reaches the 15 question level 304, then the entire prize pool is carried over to the next Game 308. In that preferred embodiment, if one or more players reach the 15 question level 305, but no player reaches the 20 question level 306, then seventy-five percent (75%) of the prize pool will be carried over to the next Game 308.

It is to be appreciated that although the above described embodiments utilize the 15 question level, a different question level can be used.

In some preferred embodiments, players of the Game will be presented with advertisements and messages from sponsors of the site during Game play and between Games.

In some preferred embodiments, players that have paid the entry fee 205 (FIG. 2) and entered a predetermined number of Games in a month will gain free entry to a monthly promotional Game with no entry fee, or a reduced entry fee, and a prize offering that is subsidized, entirely or in part, by the Game operators or the Game's sponsors.

In some preferred embodiments, a player will have the opportunity to register for the next Game, at the conclusion of each Game. In one preferred embodiment shown in FIG. 2, the replay button is a button that is labeled “Play Another Game?” 209. In some preferred embodiments, the replay button connects the user with the Game page and allows the user to play again 211. In some preferred embodiments, data received from the registration page is accessible from the gaming server so that player does not have to provide payment and other registration information again. It is to be understood that in some preferred embodiments, the replay button can access any one of the previously described pages and is not limited to re-accessing the Game page. If instead, the user chooses to terminate play, the user then exits the Game's Web site 210.

Preferred embodiments utilizing a remote kiosks will not have a replay button, or a “Play Another Game?” button. Although this element can be incorporated into the design, it is preferably not included so as to prevent fraudulent acts which could potentially occur if a player leaves a kiosk without exiting the Game. As such, in embodiments having a kiosk, a replay requires a re-inputting of the player's credit information. It is to be understood that this element is not intended to be permanently eliminated from the remote kiosk systems, or to suggest that it could not be included. Indeed, in some preferred embodiments, a timer is included that automatically exits a player from a Game within a predefined short period of time. In still other preferred embodiments, the system requests password information which has been previously entered on one of the previously described pages, such as, the registration page, which verifies the player identification.

In some preferred embodiments, a Game taking place over the wide area network 100 is coordinated with a television program. For example, but not limited to, televised in-studio players may be simultaneously presented with the same questions that are presented to players on the wide area network 100.

It is to be understood that embodiments of the instant invention can be configured to include any number of Game pages including any desired information. Indeed, the pages and information requested and/or contained on each page can be changed with each iteration of the Game if so desired. Indeed, embodiments of the invention can exclude any of the above described pages or informational inputs or include any other type of page or information input.

Further, embodiments of the instant invention are not intended to limit the manner in which the winner or winners are chosen. Indeed, the gaming provider can establish a different number of questions, time limits, number of multiple choice answers, configuration of the Game or criteria for winning players without affecting the essence of embodiments of the invention. Indeed, the disclosure is intended to include other preferred embodiments encompassing other questions, configuration of the Game or criteria for winning players. As such, the foregoing is intended to cover all modifications and alternative constructions falling within the spirit and scope of the invention.

Although the embodiments included herein describe the invention in preferred embodiments utilizing a wide area network system 100, it is to be understood that other embodiments of this invention can be implemented that utilizes other modes of communication or payment. For instance, in some preferred embodiments, players access the gaming server and play the Game via standard telephone interface means. In some preferred embodiments using a standard telephone interface means, a player calls a predetermined telephone number, and once on-line with a gaming server 101 or attendant, the player enters credit card information or other payment information, and then plays the Game by entering their choices for correct answers on the phone key pad. In some preferred embodiments, the player is automatically billed for the game on their telephone bill.

In other preferred embodiments, other types of skill games can be played on the Game's Web site and/or over a wide area network system 100.

In one preferred embodiment, a player contacts the Game's Web site 202, and registers 203 as discussed above. In some preferred embodiments, the player would select their preferred payment method and deposit funds into the Gaming Account, as discussed above.

Preferably, the payment method is a credit card or other payment selection, such as, a debit card or cyber cash, or other online currency. In some preferred embodiments, if the Gaming Account falls below a certain level, then the player must deposit additional funds into the Gaming Account prior to being permitted to play a game.

In some preferred embodiments, once a player has properly registered, they enter a game play page by selecting a “Play” hyperlink button that may be in addition to and/or distinct from the “Play” button for the Game, discussed above.

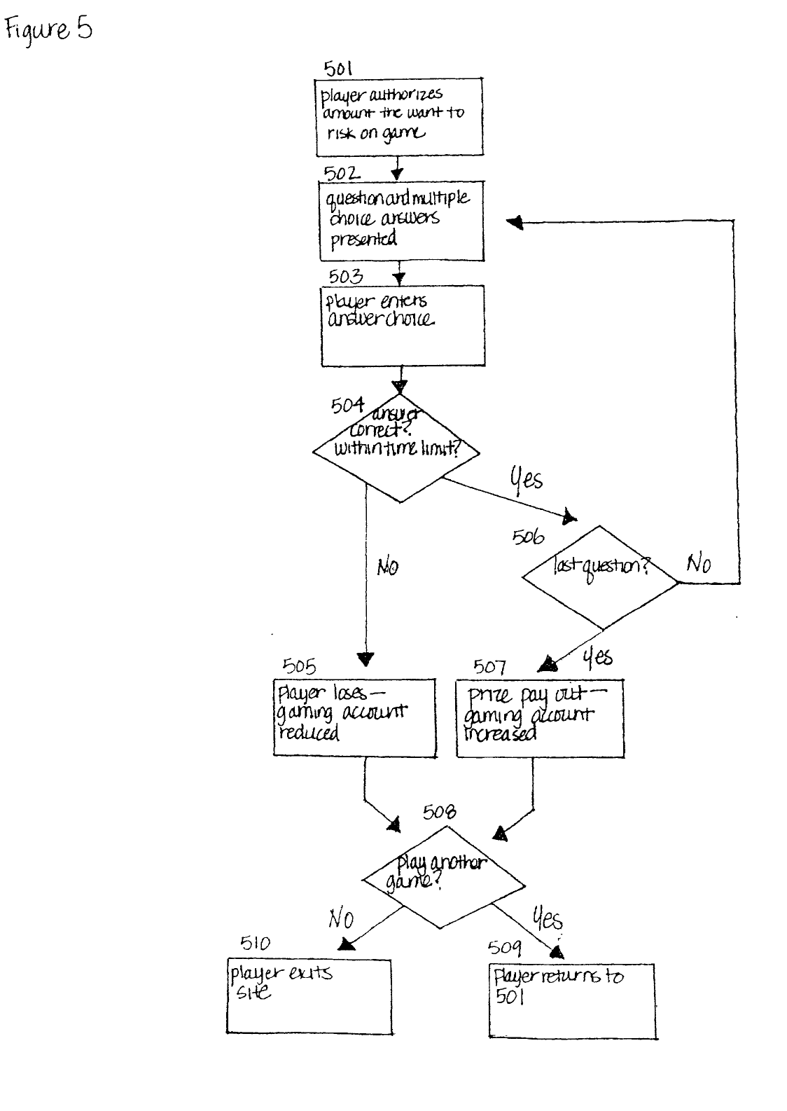

Preferably, a player then is presented with a prompt to enter the amount of money that they want to risk on the next game. The player would then enter a monetary amount that they would like to risk 501 (FIG. 5). In some preferred embodiments, minimum and maximum amounts that can be risked are established by the game operators.

In one preferred embodiment, the game consists of the player being presented with a total of five multiple-choice trivia questions that are randomly chosen out of a database of many questions 502. It is to be appreciated that although the above described embodiments utilize five questions, a different number of questions can be used. In some preferred embodiments, once a question has been presented to a player in a game, that question will never be presented to the same person again. In some preferred embodiments, the game is a single player game and questions are presented one at a time to that player only. Preferably, multiple players could be playing the game at the same time, but each of the games are independent of the other.

Preferably, the player must answer each question within a required time limit 503. In some preferred embodiments, this time limit is twelve seconds. In some preferred embodiments, once a player enters their choice for the answer to a question, then the next question will appear immediately. In other preferred embodiments, the questions appear at preselected time frames. For example, but not limited to, a new question would appear every ten seconds.

In some preferred embodiments, if the player answers all of the questions correctly,the player receives a pay-out 507. In one preferred embodiment, the amount of the pay-out is a function of the amount that the player risked on the game and the odds of a player answering all of the questions correctly, as determined by the ratio of the people that have historically answered each of the presented questions correctly to those that answered incorrectly. Preferably, the player would then receive credit in their Gaming Account for the amount of the pay-out.

In some preferred embodiments, if a player misses any of the questions, the amount that they risked on the game would be deducted from the Gaming Account and credited to the game operators 505.

In some preferred embodiments, a player will have the opportunity to commence a new game immediately at the conclusion of a game. In one preferred embodiment, the replay button is a button that is labeled “Play Another Game?” 508. Preferably, the player would then enter the amount that they would like to risk on the next game 509, or indicate that they would like to risk the same amount as the prior game. If instead, the user chooses to terminate play, the user then exits the Game's Web site 510.

In some preferred embodiments, a player can request that the player's preferred payment method be credited for a specified amount from the Gaming Account, which amount is deducted from the player's Gaming Account. In some preferred embodiments, the player can receive payment of funds from the player's Gaming Account through other means, such as, for example, being mailed a check.

It is to be understood that embodiments of the instant invention can be configured to include any number of questions, time configurations, payment methods and/or mathematical formulas for determining a player's prize winnings. As such, the foregoing is intended to cover all modifications and alternative constructions falling within the spirit and scope of the invention.

What is claimed is:

1. A method for using a computer to facilitate the playing by a number of users of a game of skill, comprising:
receiving from the computer information and instructions about a game of skill;
inputting by each player information into the computer by which an amount of money will be made available by each player to allow the player entry into a game of skill;
placing a portion of the amount of money made available by each player into a pool as the prize in the game;
reserving another portion of the amount of money made available by each player as revenue for the game operator;
outputting to each player who has inputted such information the amount of money available for distribution as prizes before each game;
outputting to each player who has inputted such information a series of questions, each question to be presented to all players nearly simultaneously;
inputting into said computer each player's answer to each of said questions within a designated time limit, allowing each player the option to pass on one question, other than the last question, in each game, which pass will count as a correct answer for the player;
awarding of a prize to all players who correctly answer a given number of consecutive questions correctly within the designated time limit, a pro-rata share from the prize pool;
awarding of a prize to all players who correctly answer an additional given number of such questions correctly within the designated time limit, another pro-rata share from the prize pool; and
carrying forward, in a progressive manner, to the prize pool for the next game any portion of the prize pool that is not awarded to any players in any given game.

2. The method of claim 1, wherein a player is allowed, but not required, to authorize an additional amount of money at one or more points during the game.

3. The method of claim 1, including placing a portion of the amount of additional money made available by each player into a separate prize pool that only those players who made the additional amount of money available are eligible for.

4. The method of claim 3, including reserving another portion of the amount of additional money made available by each player as revenue for the game operator.

5. The method of claim 3, including awarding, as a prize to all players who correctly answer one or more designated questions correctly within the designated time limit, a pro-rata share from the separate prize pool.

6. The method of claim 1, wherein said series of questions are trivia questions.

7. A method for using a computer to facilitate the playing by a number of users of a game of skill, comprising:
receiving from the computer information and instructions about a game of skill;
inputting by each player information into the computer by which an amount of money will be made available by each player;
outputting to each player who has inputted such information a series of questions,
inputting into said computer each player's answer to each of said questions;
outputting to each player before each game the amount of money available for distribution as prizes; and
awarding of a prize to all players who correctly answer a given number of such questions correctly, the value of said prizes being determined, at least in part, by how many players inputted said payment information.

8. A method for using a computer to facilitate the playing by a number of users of a game of skill, comprising:
receiving from the computer information and instructions about a game of skill;
inputting by each player information into the computer by which an amount of money will be made available by each player;
coordinating said game with questions used on a television program so that each player inputs answers into said computer to the same questions asked during a television game show;
inputting into said computer from each player who chooses to answer, an answer to each of said questions, and
awarding a prize to all players who answer a given number of such questions correctly, the value of said prize being determined, at least in part, by how many players inputted said payment information.

9. A method for using a computer to facilitate the playing of a game of skill, comprising:
receiving from the computer information and instructions about a game of skill;
inputting by the player information into the computer by which an amount of money will be made available by the player;
outputting to each player who has inputted such information a series of questions, and
awarding a prize to all players who answer a given number of such questions correctly, the value of said prize being determined, at least in part, by how much money was made available by the player and, at least in part, by the ratio of the players who have historically answered each of the presented questions correctly.

10. A method for facilitating playing a game of skill comprising:
receiving at the player's site information and instructions about a game of skill;
inputting at the player's site information enabling an amount of money to be made available for playing the game of skill;
receiving at the player's site a series of questions;
answering at the player's site answers to said questions;
receiving a prize at the player's site depending upon whether a given number of questions were answered correctly, the value of said prize depending, at least in part, by how much money was made available by the player, and at least in part, by the ratio of players who have historically answered each of the presented questions correctly.

11. A method for facilitating playing a game of skill comprising:
receiving at the player's site information and instructions about a game of sill;
inputting at the player's site information enabling an amount of money to be made available for playing the game of skill;
receiving at the player's site a series of questions;
answering at the player's site answers to said questions;
receiving a prize at the player's site depending upon whether a given number of questions were answered correctly, the value size of said prize depending, at least in part, by how much money was made available by other players
